(19) United States
(12) Patent Application Publication
(10) Pub. No.: US 2008/0313183 A1
(43) Pub. Date: Dec. 18, 2008

(54) Apparatus and method for mapping feature catalogs

(76) Inventors: Charles Edward Cunningham, St. Louis, MO (US); Michael Wayne Wilkins, St. Louis, MO (US); Michael Patrick Weber, St. Louis, MO (US)

Correspondence Address: ANDREWS KURTH LLP;Intellectual Property Department, 1350 I Street, N.W., Suite 1100, Washington, DC, 20005, US

(21) Appl. No.: 12/213,145

(22) Filed: Jun. 16, 2008

Related U.S. Application Data
(60) Provisional application No. 60/929,140, filed on Jun. 14, 2007.

(51) Int. Cl. G06F 7/00

(52) U.S. Cl. 707/6

(57) ABSTRACT

A computer-implemented method, and corresponding apparatus, is used for mapping feature catalogs. The feature catalogs include features, feature attributes, and feature attribute enumerations. The method includes the steps of accessing a first feature catalog, accessing a second feature catalog, identifying features, feature attributes, and feature enumerations in the first feature catalog, identifying potentially corresponding features, feature attributes, and feature attribute enumerations in the second feature catalog, comparing the features, feature attributes, and feature attribute enumerations of the first and the second feature catalogs to determine a degree of match, and saving data indicative of each of the matches in a database to facilitate future searches and reports.

### CROSS REFERENCE TO RELATED APPLICATIONS

This application claims priority from U.S. Provisional Application 60/929,140 filed Jun. 14, 2007 entitled “APPARATUS AND METHOD FOR MAPPING FEATURE CATALOGS”, the content of which is incorporated herein in its entirety to the extent that it is consistent with this invention and application.

### BACKGROUND

A feature catalog is a collection of data (i.e., features) having certain attributes, values, and relationships. The features, attributes, and values, and their relationships, may be stored in a relational database or other database that is, in essence, the feature catalog. Different entities may develop feature catalogs for similar collections of features. For example, country A may develop a feature catalog for its airport facilities. Country B may develop a similar feature catalog for its airport facilities. However, the features in the two feature catalogs may not “match” exactly, or even remotely.

Why this difference is important becomes obvious when one asks a question such as “what airports within 500 miles of Kandahar Province support C5A aircraft?” (C5A aircraft are the largest military airlift craft in the U.S. inventory, and are capable of airlifting an Abrams MBT from the U.S. to Afghanistan.) The question could be answered simply if one had available a database of airport facilities that included that explicitly designated which could handle the C5A. In the absence of such explication, another alternative would be to search an airport feature catalog for specific features that are required for the C5A. For example, because of their size, C5A aircraft have specific runway length requirements, runway composition requirements, and may require other features, such as specific non-visual flight features, including radar navigation systems. An airport feature catalog should include both the feature (a runway) and its attributes (length, width, materials of construction), such that persons seeking an answer to the question presented above can find an answer by searching the appropriate feature catalog. But this presupposes that the entries in the feature catalog map to some standard or otherwise to another feature catalog.

The differences between the airport feature catalogs of country A and country B may be the result of language differences, idiom differences, term variations, implementation of different standards, and other factors. To compare the information contained in the two feature catalogs, some type of mapping is required. Unfortunately, such feature catalogs often contain hundreds of thousands of discrete entries, and mapping the two feature catalogs becomes practically impossible with current mapping tools.

### DESCRIPTION OF THE DRAWINGS

The detailed description will refer to the following drawings in which like numerals refer to like items, and in which:

FIG. 1 illustrates an environment in which an exemplary feature catalog resides;

FIG. 2 illustrates a common data model for a feature catalog;

FIG. 3 illustrates an exemplary system in which feature catalogs can be created, mapped, searched, and compared;

FIG. 4 illustrates an exemplary graphical user interface (GUI) used with the system of FIG. 3;

FIGS. 5-15 illustrate additional features of the GUI of FIG. 4; and

FIGS. 16 and 17 illustrate implementations of specific aspects of an algorithm used within the system of FIG. 3 to create mappings, and to retrieve and display data based on the mappings.

### DETAILED DESCRIPTION

A feature is the starting point for modeling information related to a system, product, or service to which that feature belongs. For example, in the context of a geographic information system, or a geo-spatial intelligence system, a feature is an abstraction, or digital representation, of a real world object or process that has associated with that object or process, certain geographical, spatial, and temporal information. In this geo-spatial context, examples of features include almost anything that can be placed in time and space, including desks, buildings, cities, trees, forest stands, ecosystems, delivery vehicles, snow removal routes, oil wells, oil pipelines, oil spills, and other items. Such features are usually managed in groups as feature collections.

A feature collection is a grouping of features that have common metadata and formal relationships. In the geo-spatial context, feature collections can be identified at different abstraction levels, e.g., a high abstraction level such as topography, and a low abstraction level such as roads.

A feature catalog contains definitions and descriptions of feature types, feature attributes, and feature relationships occurring in one or more sets of data, such as geographic data, together with any feature operations that may be applied. Thus, a feature catalog is a mechanism for assembling various features that comprise a feature collection into a database or file that can then be searched, compared to other feature catalogs, or used to generate reports and similar products. Returning to the example of airport facilities in country A, the associated feature catalog can be searched to locate specific airport facility features (e.g., runway length). The feature catalog can be used to compare catalogs runway capacity to runways in other countries. The feature catalog also can be used to generate periodic reports of runway availability.

A feature domain model is the definition of a domain-specific application schema for a well-known class of features, such as geo-spatial features, usually in vector form (i.e., points, lines and polygons). Examples include transportation, hydrographic, and electric utility domain models.

A general feature model is a metamodel of feature types. A feature may have properties expressed as operations, attributes, or associations. Any feature may have a number of attributes, some of which may be geometric and spatial. A feature is not defined in terms of a single geometry, but rather as a conceptually meaningful object within a particular domain, one or more of whose properties may be geometric.

Again, in the context of geo-spatial data, Geospatial Intelligence (GeoINT) agencies have partnered with the Open Geospatial Consortium (OGC) in an ongoing effort to transform current geospatial systems into a net-centric, interoperable solution. Unifying standards and technologies are being produced for data dictionaries, feature catalogs, data schemas and geospatial services. The driving force behind GeoINT's initiative is the desire to eliminate stove pipes and enable global system interoperability by:

Harmonizing the family of geospatial community dictionaries and catalogs,

Identifying and implementing community capability requirements (ISO 19131),

Standardizing geospatial schemas (GML-ISO 19136), and

Implementing COTS GeoServices (ISO 19142).

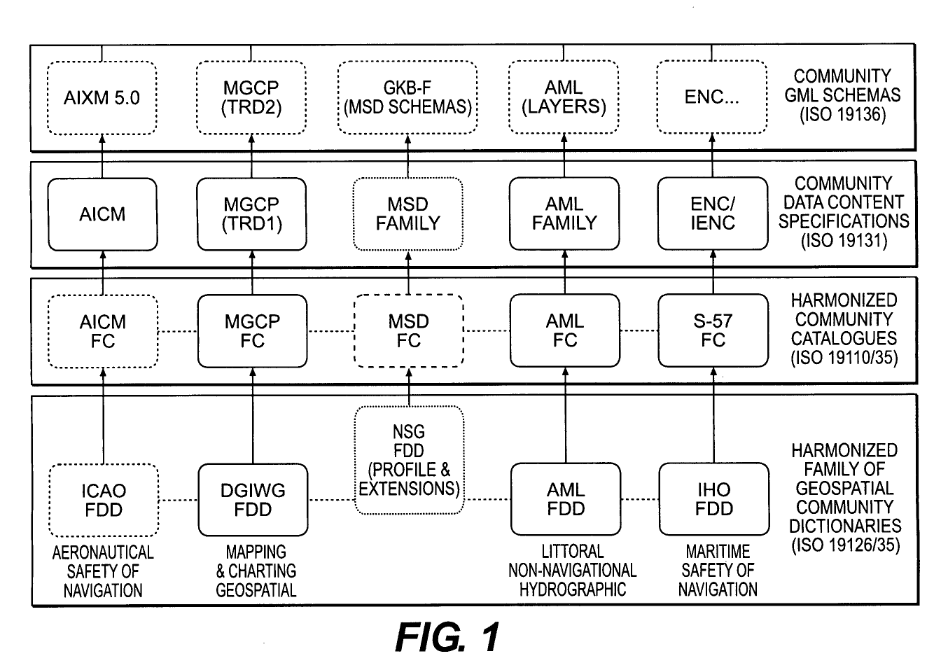

The National System of Geospatial Intelligence Entity Catalog (NSG EC, or more simply, NEC) is the backbone of the system interoperability development (see FIG. 1). The NEC includes a feature data dictionary (NSF FDD, or NFDD) that incorporates elements from other dictionaries. The NEC contains all feature information concepts to include geometries, attributes and associations used in the NSG. Drawing feature and attribute concepts from the NFDD, the NEC is based on ISO 19135/19110/19126 schema. For example, in the aeronautical community, the NEC supports a process of harmonization of legacy and emerging data standards including aeronautical flight data (e.g., DAFIF, AIXM), vertical obstruction data (DVOF), air facility data (e.g., AAFIF, Stereo Airfield Collection (SAC), DO-272, DO-291, AMXM), and standard concepts defined in ICAO conventions. The intended result of these efforts is a seamless geo-semantic base for interoperable data exchange across a wide variety of Global Information Grid participants and missions.

Within the NSG community there are many feature catalogs utilized by legacy systems which have not been mapped to the NEC. Without feature catalog mappings, data cannot be exchanged between the legacy and modern systems. Furthermore, the NEC establishes the NSG semantics of geospatial features and related application infrastructure. The NEC information model stores entities, attributes, data types, listed values, and their relationships in a generalized schema. Traditional data mapping, schema mapping, Extract Translate Load (ETL) and Enterprise Application Integration (EAI) solutions are not capable of efficiently managing multiple feature catalogs or creating efficient interoperability mechanisms between domains of differing semantics.

As mentioned previously, the NEC is a harmonization of feature data semantics from multiple geospatial disciplines such as aeronautical, maritime, and hydrographic, for example. Over time, the NEC will expand its domain as more disciplines are incorporated. Modern systems will be able to absorb these changes with little impact due to conformance to the latest GeoINT standards and technology. However, NEC changes will present a significant challenge to the brittle, stove-pipe legacy systems. Currently, legacy systems need a means of mapping to the NEC. Additionally, legacy and more modern systems need the ability to adapt to each version release of a feature catalog in order to maintain interoperability.

Within the NSG there are many types of data sets utilized in geospatial exchange, analysis and storage. For example, CIB, ARDG and NITF are common formats for imagery. The varying assortment of data sets poses a significant challenge to timely search and retrieval capabilities. Unifying data sets into a standards based library has been the focus of the NSG, requiring the collection and normalization of metadata.

However, metadata formats may vary significantly. Some are incomplete or are recorded using different values, metrics or measures. Unification efforts are especially challenging when the data sets have a wide variety of sources, collection date-times, exploitation date-times, collection methods, quality and etc. Similar to the NEC, a global metadata catalog is needed to enable efficient geospatial search, retrieval and conflation. In this environment, managing metadata standards and versions of metadata catalogs is a difficult challenge.

The herein disclosed apparatus and system, and corresponding method, involve an interoperability tool developed to facilitate feature and metadata catalog analysis, mapping and translation. The apparatus is both a short and long-term solution for the interoperability problems described above. Once mapped to the catalog, geospatial systems will be able to map to any catalog within a system conforming to the apparatus' mapping routine. This will enable interoperability between legacy to modern systems and legacy to legacy systems.

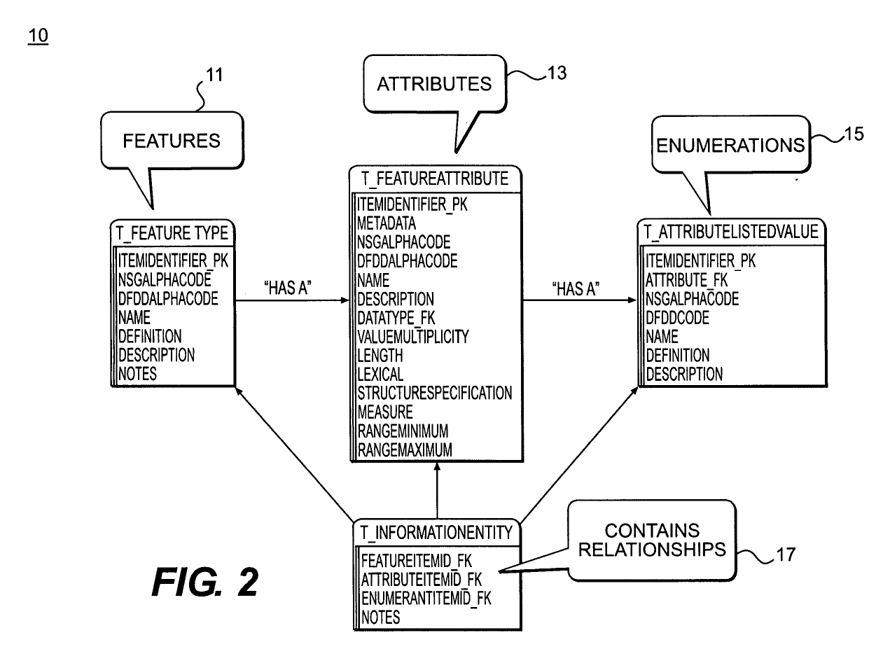

FIG. 2 illustrates an exemplary common data model for a feature catalog. In FIG. 2, common data model 10 is seen to include features 11, which have attributes 13. The attributes 13 in turn have enumerations, or values, 15. Finally, the features 11, attributes 13, and enumerations 15 have certain formal relationships 17.

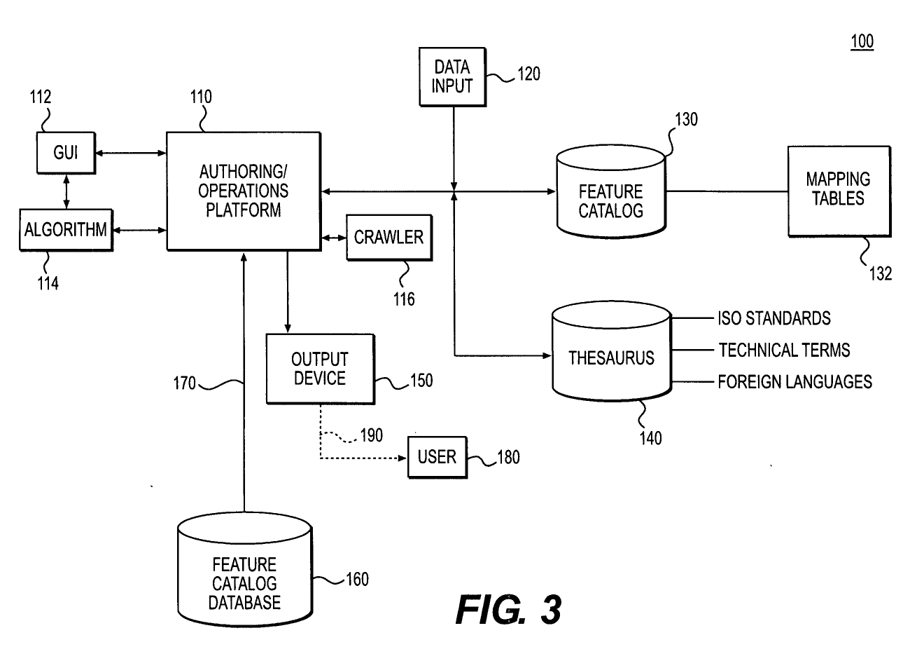

FIG. 3 illustrates an exemplary system in which feature catalogs can be created, mapped, searched, and compared, and in which various reports and products can be produced. In FIG. 3, system 100 includes authoring/operations platform 110 to which is coupled data input 120, one or more feature catalogs 130, thesaurus 140, and output device 150. Also coupled to the platform 110 are one or more feature catalogs or databases 160, which may be coupled by way of connection 170. Finally, a user 180 may access the feature catalogs 130, and the platform 110 using communications channel 190. For example, the user 180 may lunch a Web browser and access the catalogs 130 using the Internet (190).

Although the system 100 illustrates only one platform 110, the system 100 may comprise a plurality of platforms 110, and these platforms 110 may be connected by any known communications means including an intranet and the Internet, for example, and such communications means additionally may be wired or wireless. Furthermore, the catalog 160 may be coupled to the platform 110 by any known communications means including wired and wireless intranet and Internet connections, or may be made available to the platform 110 on a physical storage medium such as a DVD or portable hard drive, for example.

The data input 120 may include feature data to be collated into a feature catalog, such as one of the feature catalogs 130. The data input may follow a specific semantic, or may be “free-form” data that an analyst must conform to the specified semantic. The thesaurus 140 may include alternatives for many features, and may include foreign language translations.

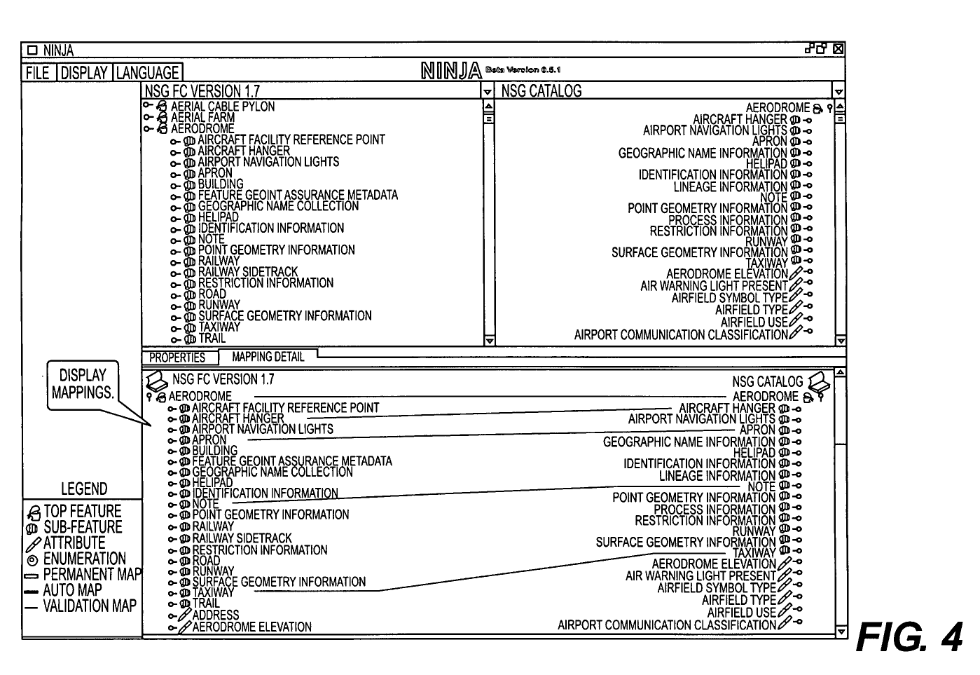

Essentially, there are two modes for interoperability development using the platform 110: Authoring and Operations. During the authoring mode, an analyst maps the catalog 130 to any catalog within the system 100. The platform 110 provides an intuitive GUI (see FIG. 4, for example) that enables the analyst to:
Browse feature catalogs side by side
Map between feature catalogs and persist mappings 132 in a database or as a part of the feature catalog 130 itself
Search feature catalogs 130
Modify feature catalogs 130
Report on differences or specialized queries
Enable analysts to collaborate in a network environment
Generate XML schemas or profiles of any feature catalog 130
Translate feature catalogs into different languages

A very powerful feature of the disclosed platform 110 is catalog (foreign) language translation. In the authoring phase, analysts may translate catalogs into their own language. The language mappings are then stored in the mapping tables 132 and can be referenced during the operations phase. Once translations are established, users 180 can then access the feature catalogs 130 in other languages. Therefore, geo-spatial systems will be able to exchange and translate data regardless of language.

The platform 110 is suitably programmed with mapping algorithm 114 to provided mappings and subsequent comparisons, searches, and reports. The algorithm 114 incorporates GUI 112 for intuitive manual mapping of feature and attribute data. An exemplary GUI is shown in FIG. 4. The algorithm 114 also includes the logic to perform automated mapping of feature and attribute data. In the manual and automated mode, the algorithm 114 may employ crawler 116 to locate specific data to be used to create and modify the feature catalogs 130 and to map feature catalogs 130 to other catalogs 160.

In the operations mode, geo-spatial systems process incoming messages 120 and use the mapping tables 132, created in the authoring mode, to validate, transform and/or translate data. Users 180 may access the mappings 132 through a Web services interface (i.e., output device 150) or directly using database connections. For example, the user may display mappings 132 under the following criteria:

features that match by name

features that match by name and attributes

features that match by name, attributes, and attribute enumerations (values)

features that have an exact match

features that have a similar match

features that have a vague match

features that do not match

FIG. 4 illustrates an exemplary GUI 112 that is used with the platform 110 to create the mappings 132. Illustrated in FIG. 4 is the use of the GUI 112 to map features from an NSG feature catalog (i.e., the NEC) to a similar feature catalog (IMC feature catalog).

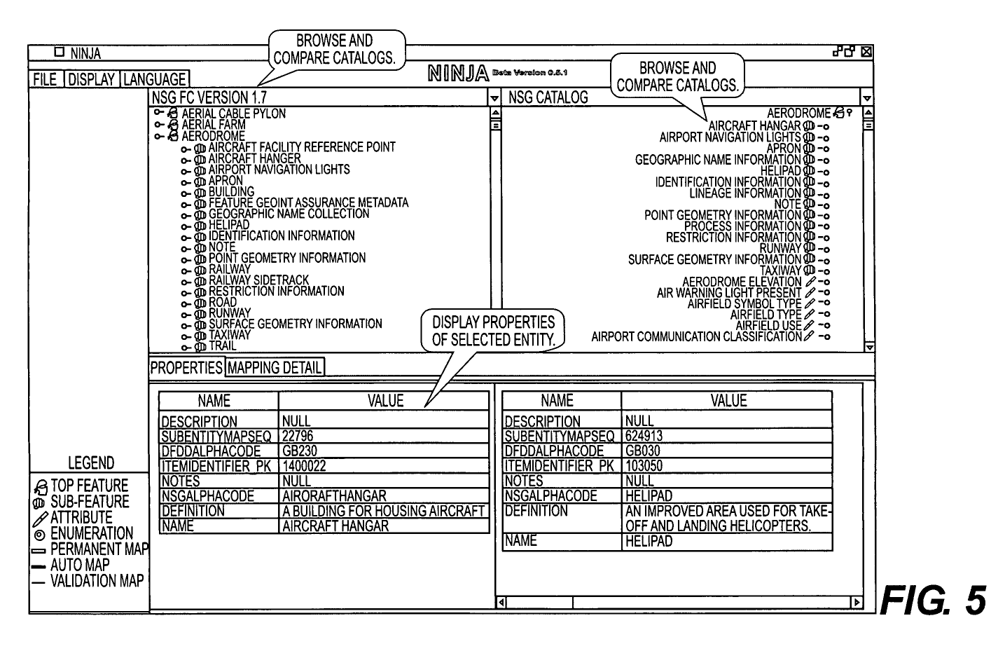

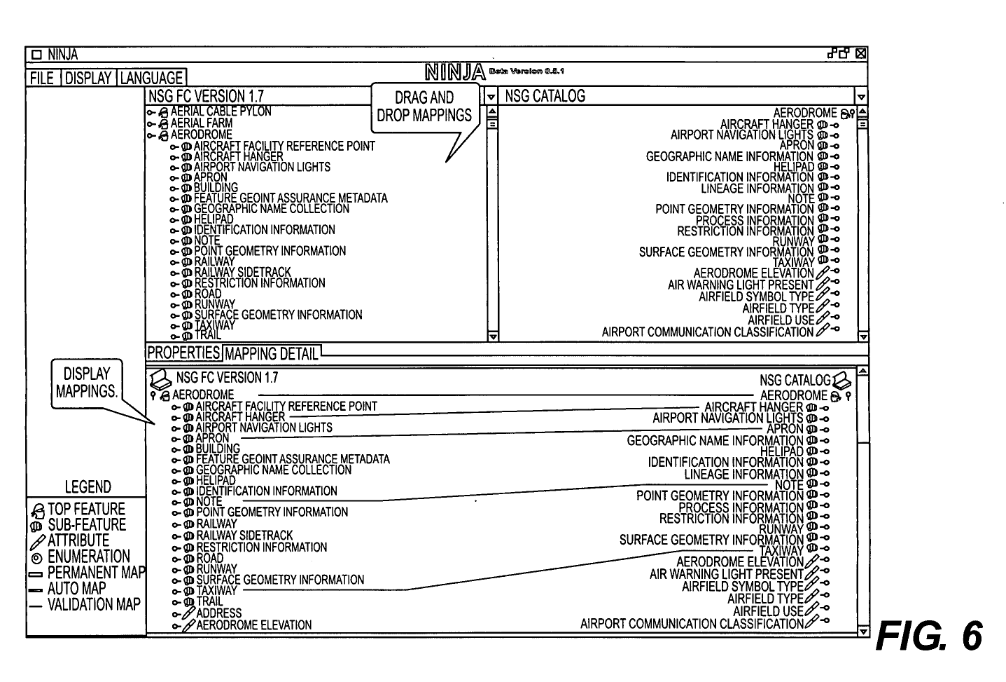

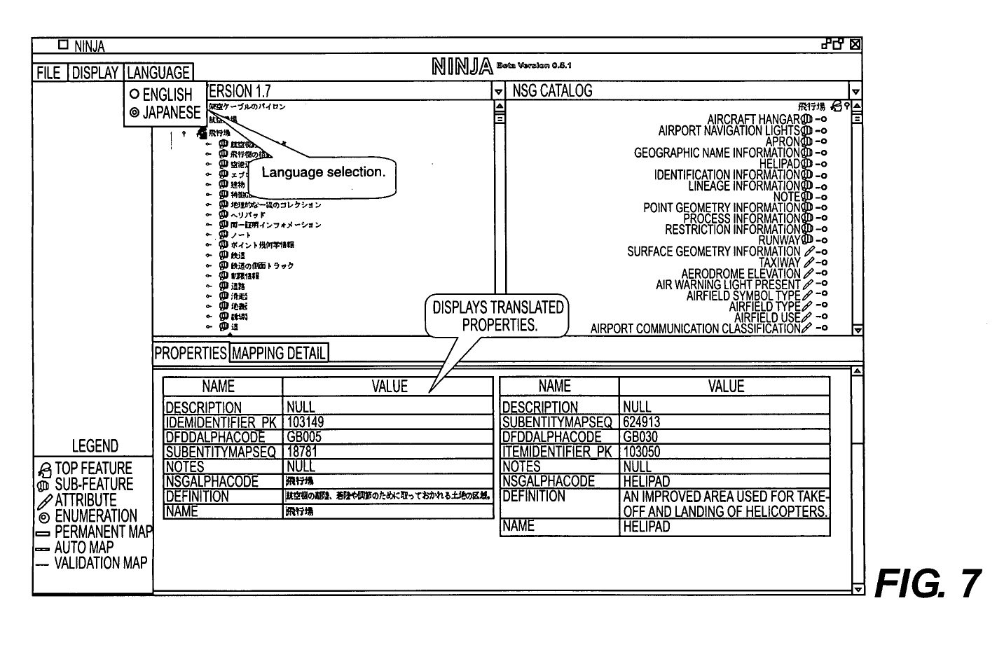

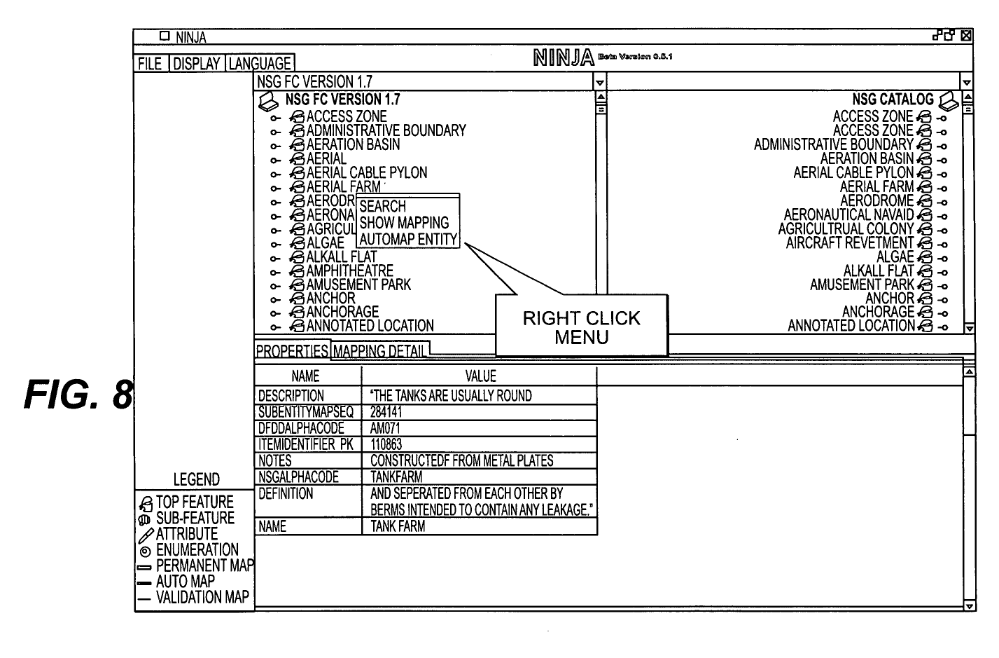

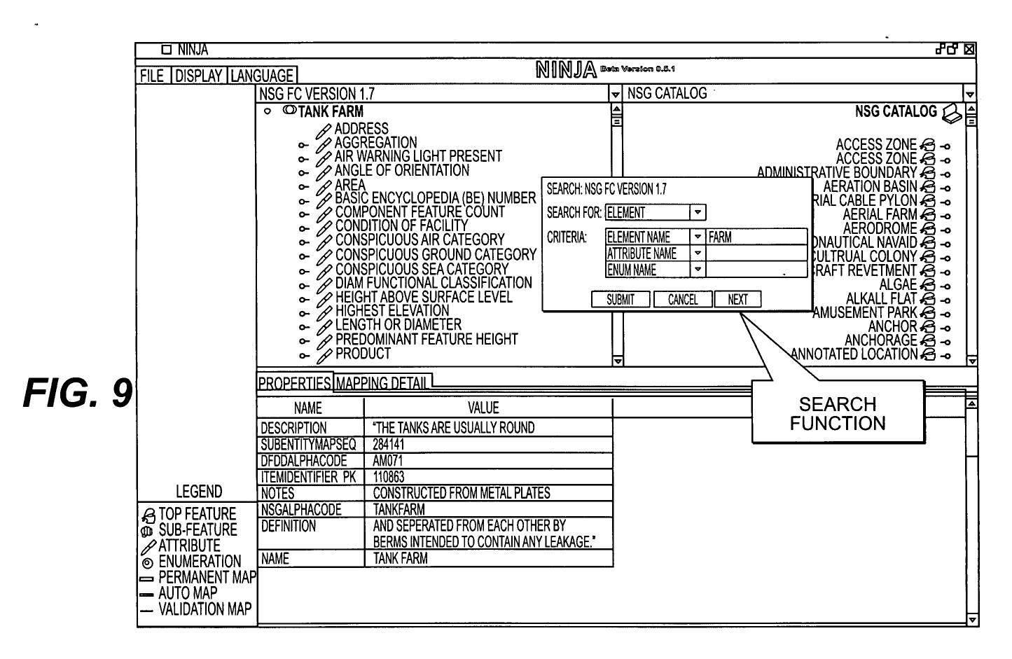

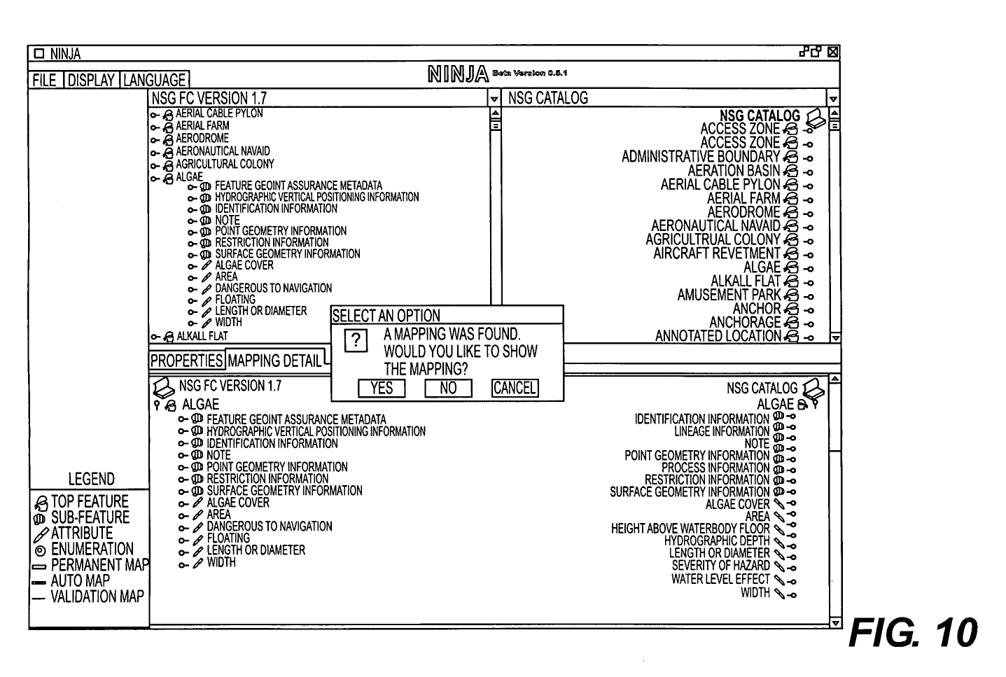

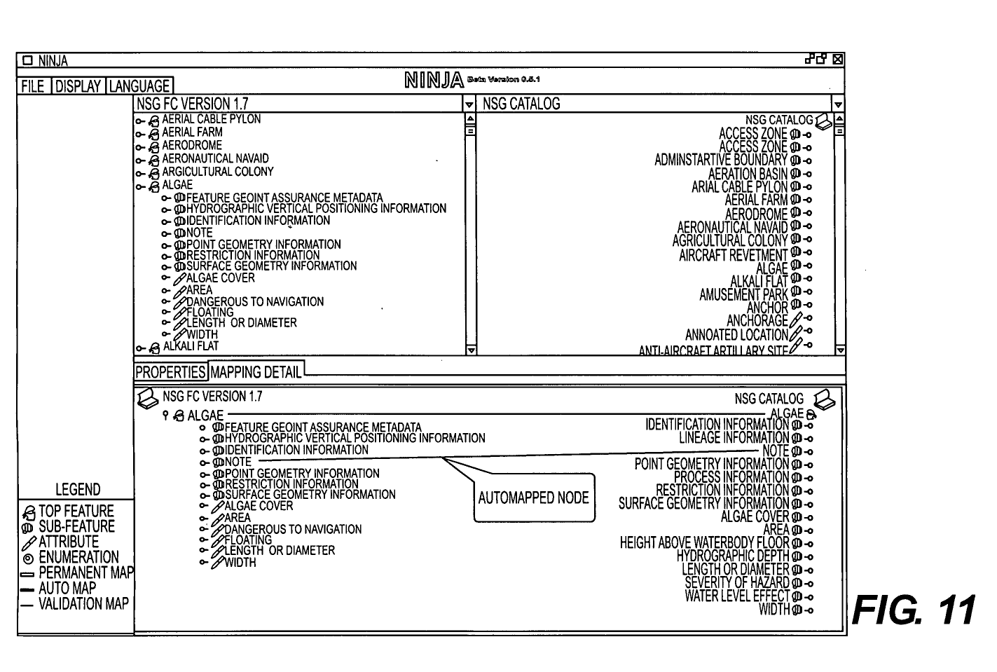

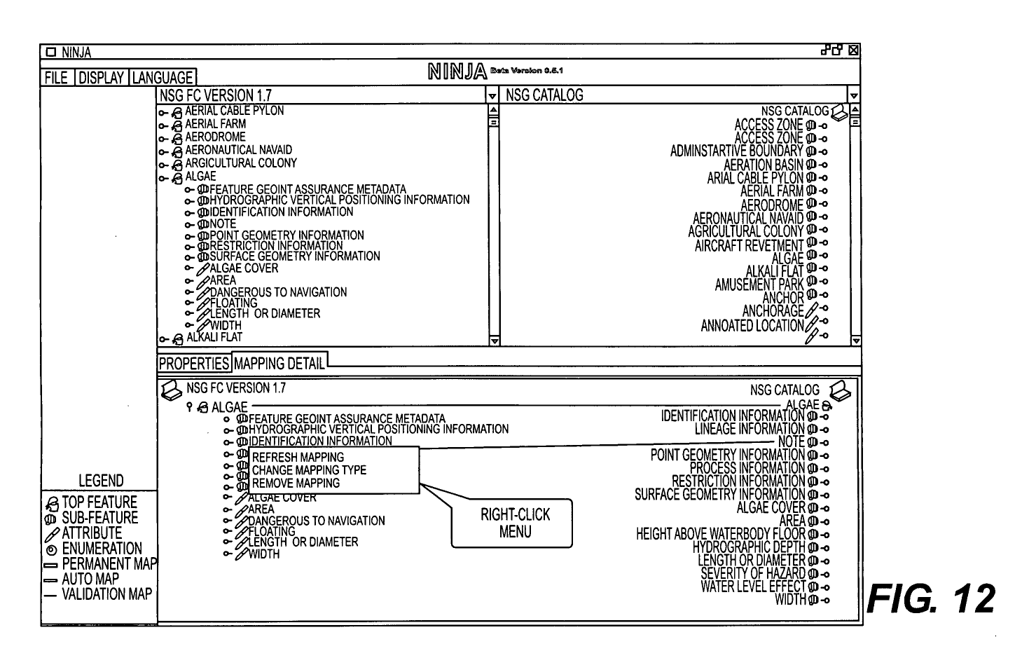

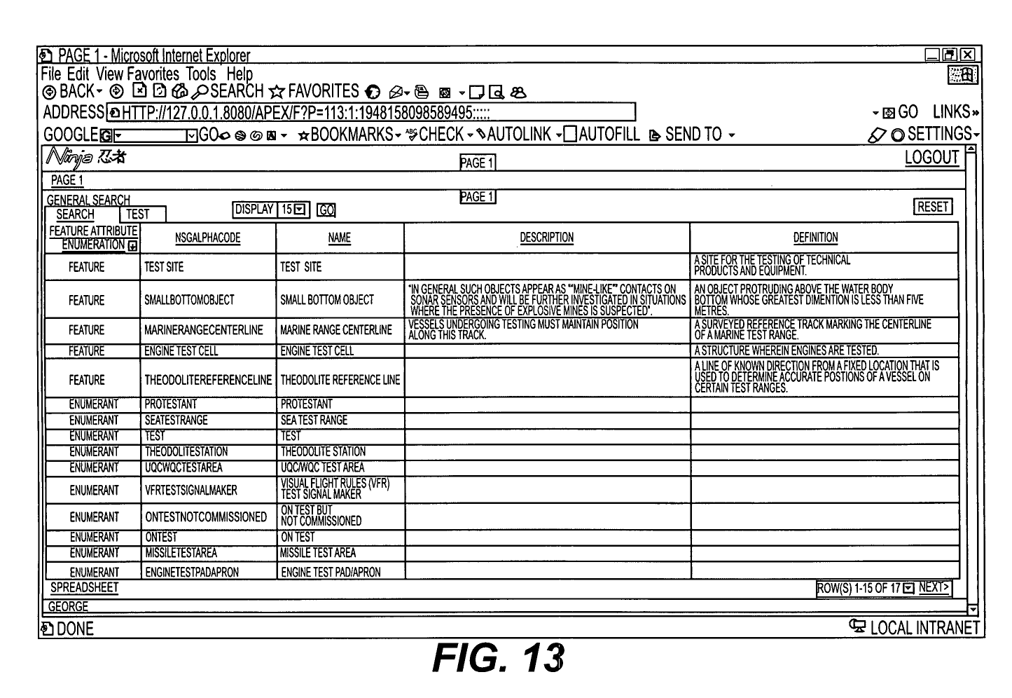

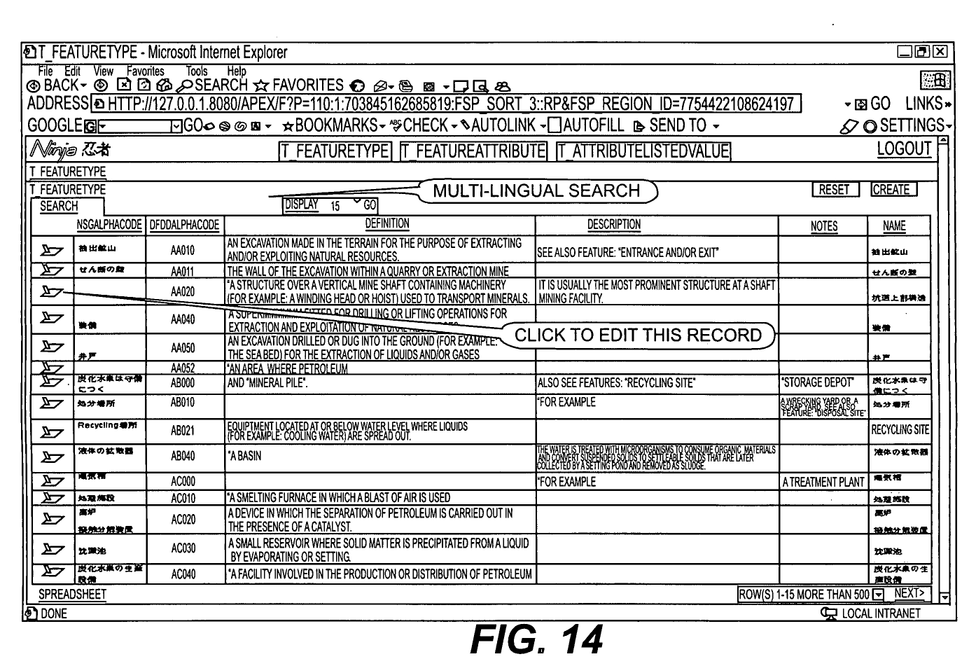

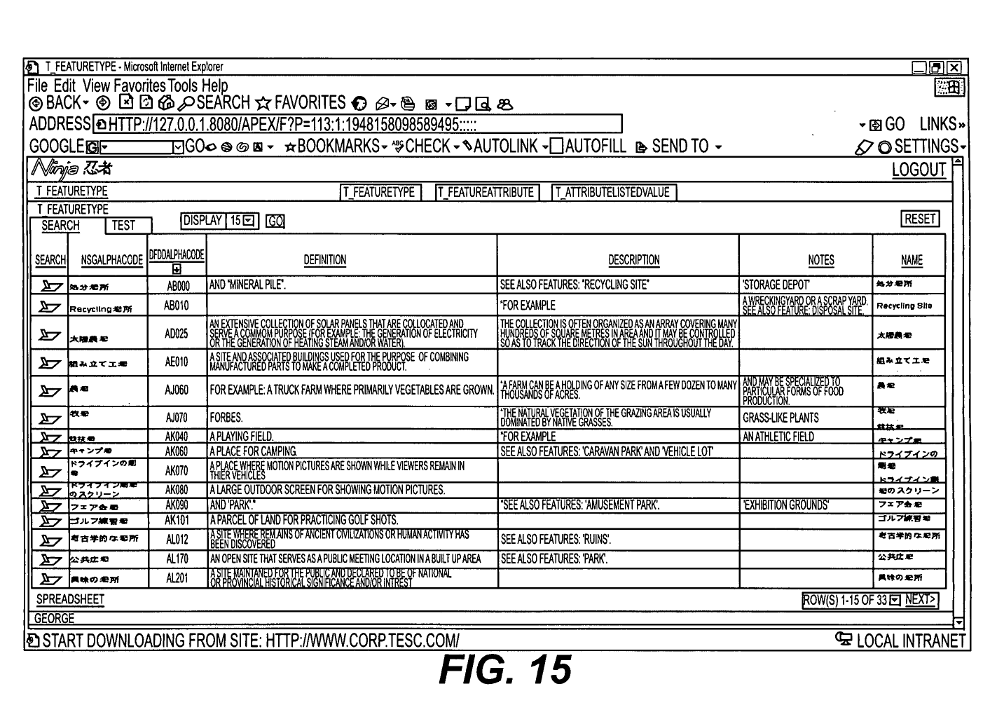

FIGS. 5-15 illustrate other features of the GUI 112.

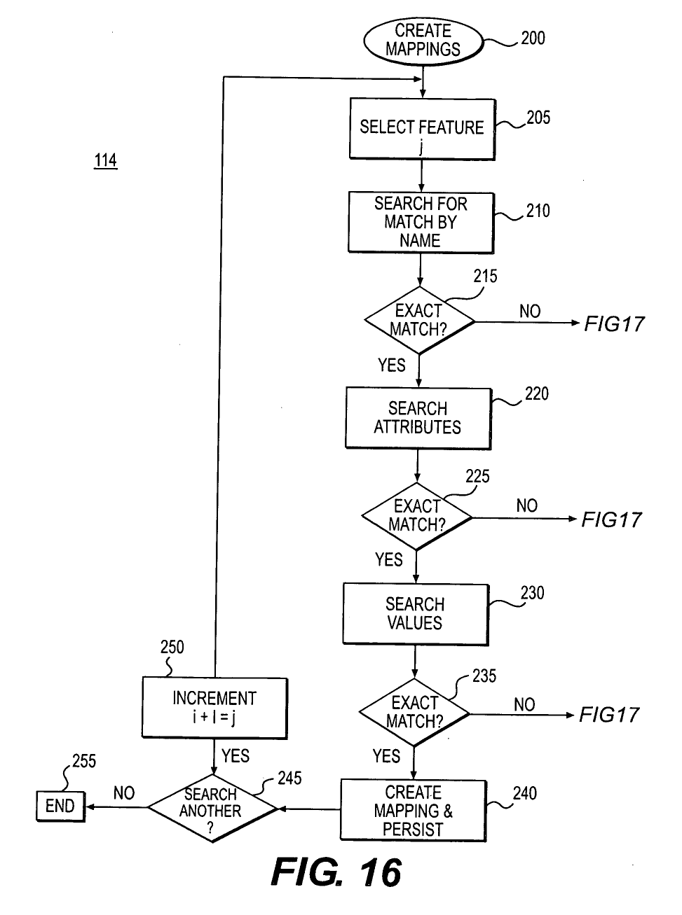

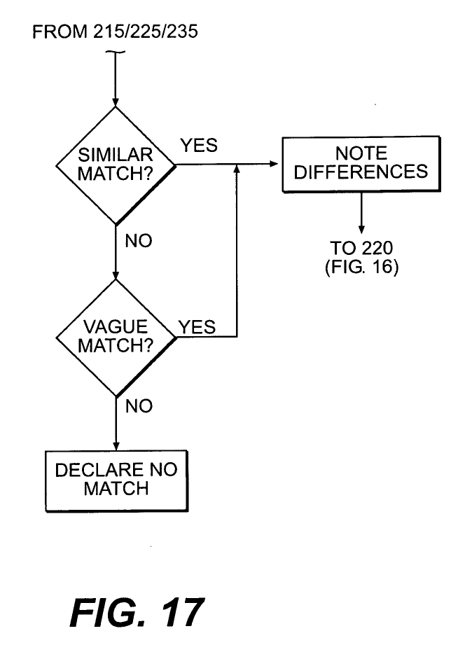

FIGS. 16 and 17 illustrate implementations of specific aspects of the algorithm 114. The algorithm 114 may be particularly useful when making complex mappings or when mapping feature catalogs with numerous entries. In fact, without the algorithm 114, many feature catalog mappings would not be possible, given the time and effort required for a human operator to map features. The algorithm 114, in executing the mappings, may provide automated services, or may make suggested mappings that are approved by a human user before final implementation.

As shown in FIG. 16 and 17, the algorithm 114 executes a series of tests to determine the degree of matching between features, attributes, and values of two feature catalogs. When exact matches occur, the algorithm 114 may establish a mapping. If an exact match does not occur, the algorithm executes additional tests to determine is a similar or a vague match exists. Similar and vague matches may be sufficient to establish a mapping. If no degree of matching is found, the algorithm 114 may declare a non-matching condition.

When testing the degree of matching, the algorithm may consult the thesaurus 140, or other information source. Matching may be indicated by a close enough result from the specific test. For example, the feature name “runway” in one catalog may be deemed to “match” the feature name “airstrip” in another catalog. Similar idiomatic differences may exist between feature catalogs, particularly where such feature catalogs originate from different contexts, professional societies, government agencies, and countries, for example. Similarly, attributes and attribute enumerations may be expressed according to different measurement systems (metric or English, for example). The attribute “runway strength”, expressed in one catalog as a loading (kpsi) may be deemed to match an ISO standard expressed in another catalog. A value of 12,000 feet for runway length (attribute) may be deemed to “match” a runway length of 4,000 meters expressed in another catalog. In terms of value, the degree (exact, similar, vague, none) of “match” may be based on a range or tolerance limit. For example, the runway length of 12,000 feet may be an exact match for a length of 4,000 meter, a similar match for a length of 3,800 meter, a vague match for a length of 3,600 meters, and no match for any values less than 3,600 meters. Other “rules” for determining the degree of match may be constructed by the analyst, or borrowed from other catalog constructions and other sources. Also built into the algorithm 114 is the ability to compare acronyms to the full names they stand in for, idioms used by different countries and regions, and by different industry groups, and foreign languages.

To automate the mapping, the algorithm 114 may employ crawler 116 to “crawl” or search another catalog (e.g., catalog 160) to look for instances of matching (exact, similar, vague, none) matches between feature names, attributes, and values. The crawler 116, unlike a standard Web crawler or a search engine, makes on-the-fly “decisions” according to its programming, as to whether feature names, attributes, and values match, and to what degree. For example, the crawler 116 may search a feature catalog 160 for instances of the feature name runway. An exact, similar, or vague match may be found. If one of these “matches” is found, the crawler 116 then executes a secondary search for that feature's attributes, and again determines the degree of match. If the search for feature attributes indicates no match, then the crawler 116 may revisit its “decision” regarding the feature name, and declare no match for the feature name. However, if there is a sufficient degree of match, the crawler 116 may confirm its “decision” and execute a tertiary search for attribute values. If the attribute values do not match, the feature name and attributes may still match. Thus, the crawler 116 uses the determined degree of match to further search the catalog 160, and as a feedback mechanism for its match decisions.

The algorithm 114, and the associated crawler 116 may also be used to update or modify the feature catalog 130. For example, an incoming GIS message 120 may include an update to spatial data concerning airport facilities in Afghanistan. The crawler 116, under the automated control of the algorithm 114 searches the message 120 to determine if any features, attributes, or enumerations related to the feature catalog 130 should be modified. In one embodiment, the algorithm 114 makes this modification. In another embodiment, the algorithm 114 makes the modification and provides a change notice to the user 180. In yet another embodiment, the algorithm 114 makes a proposed change, and waits until that change is approved (either by the original analyst, the user 180, or another party). Besides spatial modification, the feature catalog 130 also may be modified based on temporal changes. For example, an earthquake in Kandahar Province may render an airport totally inoperative, or may disable the airport's radar navigation system. Such a temporal change may be provided to the user 180 by way of a GIS message 120. As with a spatial change, the algorithm 114 can modify the feature catalog 130 to make note of this condition. In addition, the algorithm 114 can note, in the feature catalog 130, that the modification may be temporary, and may provide a prompt to the user 180 to periodically check the airport's status.

The various disclosed embodiments may be implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, DC-ROM, ROM, etc. The code is distributed on such media, or is distributed to users from the memory or storage of one computer system over a network of some type to other computer systems for use by users of such other systems. Alternatively, the programming code is embodied in the memory (such as memory of a handheld portable electronic device) and accessed by a processor using a bus. The techniques and methods for embodying software programming code in memory, on physical media, and/or distributing software code via networks are well known and will not be further discussed herein.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

We claim:

1. A suitably programmed computing device for use with information systems having two or more feature catalog, each of the feature catalogs comprising features, feature attributes, and feature enumerations, the computing device programmed to map a first feature catalog to a second and subsequent feature catalogs, wherein the programming comprises the steps of:
sending a crawler to search the second feature catalog for instances of matches between a first feature of the first feature catalog and a corresponding feature of the second feature catalog;
determining a degree of match of the first and corresponding features;
if the degree of match is sufficient, searching, using the crawler, feature attributes of the corresponding feature that match first feature attributes;
determining a degree of match of the first and the corresponding feature attributes; and
if the degree of match is sufficient, searching, using the crawler, feature attribute enumerations of the corresponding feature attributes that match first feature attribute enumerations.

2. The computing device of claim 1, wherein the feature attributes include geometric and spatial properties.

3. The computing device of claim 1, wherein the first feature attribute enumerations are expressed in a first measurement system and the enumerations of the corresponding feature attributes are expressed in a second measurement system, and wherein the programming comprises transforming between the first and the second measurement systems.

4. The computing device of claim 1, wherein the first and the second feature catalogs are stored on different nodes on a network.

5. The computing device of claim 4, wherein the network in the Internet.

6. The computing device of claim 1, wherein the features, feature attributes, and feature enumerations of the first and the second and subsequent feature catalogs are expressed in different languages, and wherein the programming steps further comprise translating between the different languages.

7. The computing device of claim 6, wherein the programming further comprises storing the translations.

8. The computing device of claim 1, wherein the programming further comprises the steps of mapping features between the first feature catalog and the second and subsequent feature catalogs and storing the mappings for use in subsequent reports, searches, transformation services and translation services.

9. The computing device of claim 8, wherein the programming further comprises the step of displaying the mappings.

10. The computing device of claim 9, wherein the mappings are displayed by one or more of features that match by name, features that match by name and attributes, and features that match by name, attributes and attribute enumerations.

11. The computing device of claim 10, wherein in the displayed mappings include features that do not match.

12. The computing device of claim 1, wherein the mapping is executed by the programming automatically.

13. The computing device of claim 1, wherein the mapping comprises suggested mappings, and wherein final mappings are approved by a user.

14. A computer-implemented method for mapping feature catalogs, the feature catalogs including features, feature attributes, and feature attribute enumerations, the method comprising:
accessing a first feature catalog;
accessing a second feature catalog;
identifying features, feature attributes, and feature enumerations in the first feature catalog;
identifying potentially corresponding features, feature attributes, and feature attribute enumerations in the second feature catalog;
comparing the features, feature attributes, and feature attribute enumerations of the first and the second feature catalogs to determine a degree of match; and
saving data indicative of each of the matches in a database to facilitate future reports, searches, transformation services and translation services.

15. The method of claim 14, wherein the feature attributes and the feature attribute enumerations in the between the first and the second feature catalogs are stated in different measurement systems, the method further comprising translating between the different measurement systems to determine the degree of match.

16. The method of claim 14, wherein one or more of the features, feature attributes, and feature attribute enumerations between the first and the second feature catalogs are stated in different languages, the method further comprising translating between the different languages to determine the degree of match.

17. The method of claim 14, wherein one or more of the features, feature attributes, and feature attribute enumerations between the first and the second feature catalogs are stated in different idiomatic contexts, the method further comprising translating between the different idiomatic contexts.

18. The method of claim 14, wherein one or more of the features, feature attributes, and feature attribute enumerations between the first and the second feature catalogs are expressed as acronyms, the method further comprising translating between the acronyms and terms from which the acronyms derive.

19. The method of claim 14, wherein the degrees of match comprise one of an exact match, a similar match, a vague match, and no match.

20. A computer readable medium comprising programming to be executed by a suitable computing device, the programming, when executed, comprising the steps of:
accessing a first feature catalog;
accessing a second feature catalog;
identifying features, feature attributes, and feature enumerations in the first feature catalog;
identifying potentially corresponding features, feature attributes, and feature attribute enumerations in the second feature catalog;
comparing the features, feature attributes, and feature attribute enumerations of the first and the second feature catalogs to determine a degree of match; and
saving data indicative of each of the matches in a database to facilitate future reports, searches, transformation services and translation services.
